(19) United States
(12) Patent Application Publication
(10) Pub. No.: US 2012/0073287 A1
(43) Pub. Date: Mar. 29, 2012

(54) TURBOCHARGER HAVING ANTI-SURGE VALVE

(75) Inventors: Sang Kyu Kang, Hwaseong-si (KR); Hyung Jin Kim, Seoul (KR); Jong Kyu Lee, Bucheon-si (KR); Jaeheon Kim, Seongnam-si (KR)

(73) Assignee: Hyundai Motor Company, Seoul (KR)

(21) Appl. No.: 12/958,046

(22) Filed: Dec. 1, 2010

(30) Foreign Application Priority Data
Sep. 29, 2010 (KR) 10-2010-0094716

(51) Int. Cl. F02D 23/00

(52) U.S. Cl. 60/602

(57) ABSTRACT

A turbocharger having an anti-surge valve may include a compressor that may be disposed at an intake line to compress intake air, and the anti-surge valve that selectively fluid-connects the downstream and the upstream of the compressor to circulate the intake air from the downstream to the upstream of the intake line, wherein a passage communicating with the downstream of the intake line may be formed in the anti-surge valve and the intake air flowing through the passage may be supplied to an edge portion outside a rotation center of a blade of the compressor.

### CROSS-REFERENCE TO RELATED APPLICATION

The present application claims priority to Korean Patent Application No. 10-2010-0094716 filed in the Korean Intellectual Property Office on Sep. 29, 2010, the entire contents of which is incorporated herein for all purposes by this reference.

### BACKGROUND OF THE INVENTION

1. Field of the Invention

The present invention relates to a turbo device having an anti-surge valve. More particularly, the present invention relates to a turbocharger having an anti-surge valve circulating reversed air to an upstream side of a compressor when a throttle valve is closed.

2. Description of Related Art

A gasoline engine uses a throttle valve to control intake air, and the intake air can flow backwards at a point of a tip-out (a behavior of taking a driver's foot off the accelerator).

Particularly, in a case that a turbocharger is mounted therein, the reversed intake air collides with a blade of a compressor to generate noise and vibration and to deteriorate the durability thereof.

So as to resolve the above problem, a bypass line is formed between an upstream side and a downstream side, and an anti-surge valve is disposed on the bypass line.

So as to reduce the noise and vibration generated from the blade of the compressor, the anti-surge valve opens the bypass line to re-circulate the air between the throttle valve and the compressor.

Meanwhile, the air re-circulating to the compressor collides with the blade of the compressor, which rotates at a high speed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a turbocharger having an anti-surge valve having advantages of reducing noise generated by circulating air between a compressor of a turbocharger and a throttle valve.

In aspect of the present invention, the turbocharger having an anti-surge valve, may include a compressor that may be disposed at an intake line to compress intake air, and the anti-surge valve that selectively fluid-connects the downstream and the upstream of the compressor to circulate the intake air from the downstream to the upstream of the intake line, wherein a passage communicating with the downstream of the intake line may be formed in the anti-surge valve and the intake air flowing through the passage may be supplied to an edge portion outside a rotation center of a blade of the compressor.

An average flowing velocity line of the intake air that may be exhausted from the passage of the anti-surge valve to flow into the blade of the compressor may be formed towards a rotating direction of the blade, wherein an inlet opening of the passage may be larger than an outlet opening thereof to form a cone shape and wherein the outlet opening of the passage may be aligned such that the average flowing velocity line may be tangential to a rotation trace of the blade.

The average flowing velocity line of the intake air that may be exhausted from the passage of the anti-surge valve to flow into the blade of the compressor may be formed, and a hypothetical line that connects an inlet center of the passage to the rotation center of the blade forms a predetermined angle with the average flowing velocity line, wherein an inlet opening of the passage may be larger than an outlet opening thereof to form a cone shape, and wherein the outlet opening of the passage may be aligned such that the average flowing velocity line may be tangential to a rotation trace of the blade, and wherein the predetermined angle that may be formed between the hypothetical line and the average flowing velocity line may be at least 15 degrees.

The anti-surge valve may include an opening/closing unit that controls the intake air flowing into the passage, and wherein a lift height of the opening/closing unit may be equal to or larger than an inlet diameter of the passage, wherein one side surface of a valve plate contacting the opening/closing unit may be flat, and the intake air flowing into an inlet of the opening/closing unit changes its moving direction 180 degrees to be exhausted through a passage inlet.

The average flowing velocity line of the intake air that may be exhausted from the passage of the anti-surge valve to flow into the blade of the compressor may be formed, a crossing point may be formed where the average flowing velocity line and a rotation trace of the blade cross each other, and a horizontal line that passes the crossing point and the rotation center of the blade may be formed, wherein the average flowing velocity line and the horizontal line form a predetermined angle, wherein an inlet opening of the passage may be larger than an outlet opening thereof to form a cone shape, wherein the outlet opening of the passage may be aligned such that the average flowing velocity line may be tangential to the rotation trace of the blade, and wherein the predetermined angle that may be formed by the average flowing velocity line and the horizontal line may be at least 15 degrees.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram showing a state in which an anti-surge valve does not operate in a turbocharger having an anti-surge valve according to an exemplary embodiment of the present invention.

FIG. 2 is a schematic diagram showing a state in which an anti-surge valve operates in a turbocharger having an anti-surge valve according to an exemplary embodiment of the present invention.

FIG. 3 is a partial cross-sectional view showing the internal structure of an anti-surge valve according to an exemplary embodiment of the present invention.

FIG. 4 is a diagram showing an air stream flowing in an anti-surge valve according to an exemplary embodiment of the present invention.

FIG. 5 is a schematic cross-sectional view of an anti-surge valve according to an exemplary embodiment of the present invention.

FIG. 6 is a diagram showing a principle of generating noise in a blade of a compressor according to an exemplary embodiment of the present invention.

FIG. 7 is a graph showing effectiveness according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

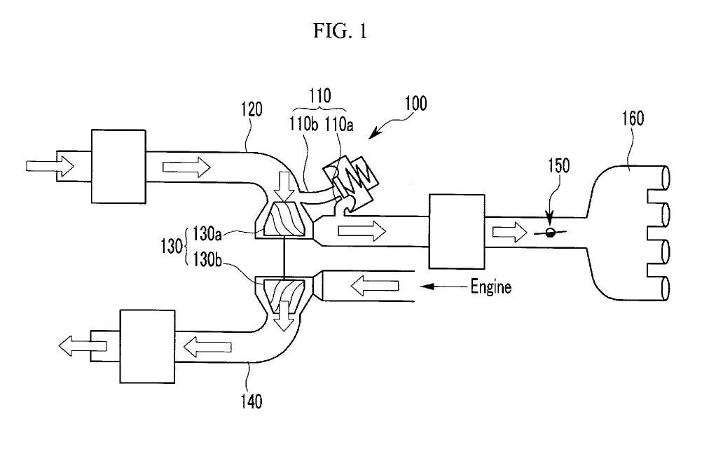

FIG. 1 is a schematic diagram showing a state in which an anti-surge valve does not operate in a turbocharger having an anti-surge valve according to an exemplary embodiment of the present invention.

Referring to FIG. 1, a turbocharger having an anti-surge valve includes an intake line 120, a throttle valve 150, an intake manifold 160, an exhaust line 140, a turbocharger 130, and an anti-surge valve 100.

The turbocharger 130 includes a turbine 130b disposed at the exhaust line 140 and a compressor 130a disposed at the intake line 120, and a bypass line 110 is diverged from the intake line 120 at the downstream side of the compressor 130a to join the intake line 120 at the upstream side of the compressor 130a.

The anti-surge valve 100 is mounted on the bypass line 110, a first bypass line 110a is formed from the intake line 120 to the anti-surge valve 100, and a second bypass line 110b is formed from the anti-surge valve 100 to the intake line 120.

If a driver pushes an accelerator pedal, air is induced through the intake line 120, the air flows through the compressor 130a, the throttle valve 150, and the intake manifold 160, and the exhaust gas combusted with fuel is exhausted to the atmosphere through the turbine 130b of the exhaust line 140.

The turbine 130b is rotated by the exhaust gas to rotate the compressor 130a so that the compressed air is efficiently supplied through the intake line 120.

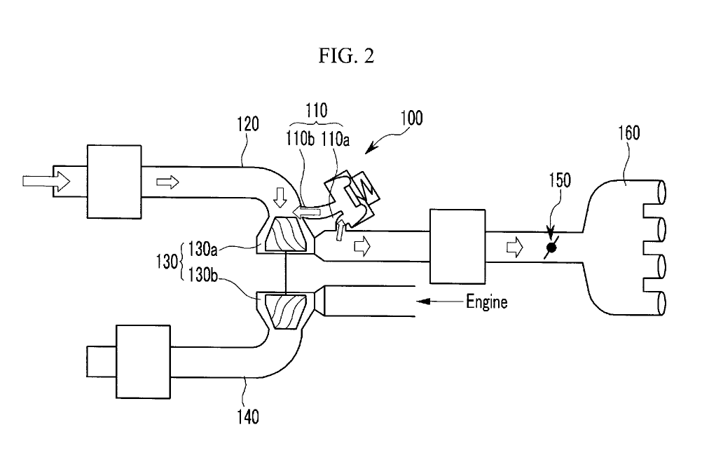

FIG. 2 is a schematic diagram showing a state in which an anti-surge valve operates in a turbocharger having an anti-surge valve according to an exemplary embodiment of the present invention.

Referring to FIG. 2, if the driver's foot is taken off the accelerator pedal, the throttle valve 150 is instantly closed, and if the pressure between the compressor 130a and the throttle valve 150 is raised, the anti-surge valve 100 is opened.

Meanwhile, while the compressed air is supplied to the upstream side of the compressor 130a through the first bypass line 110a, the anti-surge valve 100, and the second bypass line 110b, the compressed air collides with the blade of the compressor 130a to generate a high level of noise.

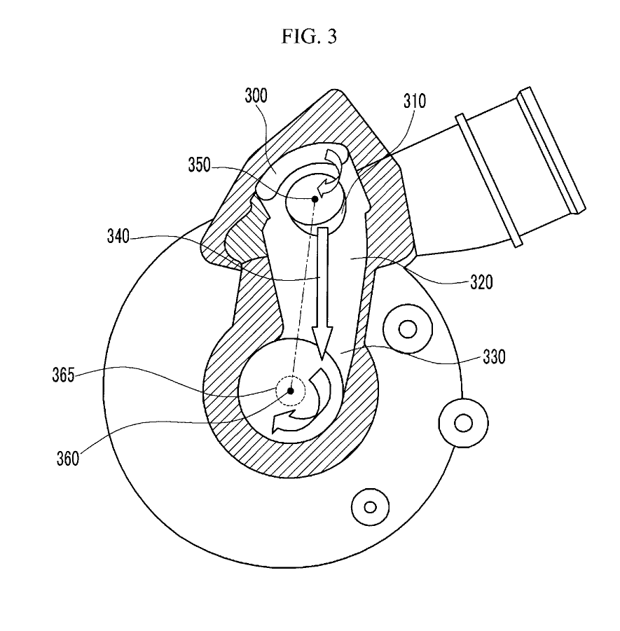

FIG. 3 is a partial cross-sectional view showing the internal structure of an anti-surge valve according to an exemplary embodiment of the present invention.

Referring to FIG. 3, an inlet 300 is formed at the anti-surge valve 100, which is connected to the first bypass line 110a, and the bypass air flowing into through the inlet 300 flows through a passage 320 to the intake line 120.

The second bypass line 110b that is described in FIG. 2 corresponds to the passage 320 described in FIG. 3, and if there is no specific comments, it can be determined that the constituent elements are the same.

The blade of the compressor 130a is disposed inside the intake line 120 to rotate at a high speed, and the blade rotates based on a rotation center 360 thereof.

The air flowing into a passage inlet 310 of the passage 320 is supplied to the blade of the compressor 130a through a passage outlet 330, and the air is supplied to an edge portion except a rotation center portion 365 of the blade.

Particularly, the air flowing in the passage 320 is supplied in a rotation direction of the blade such that the noise generated when the air collides with the blade is reduced.

As shown, a line passing an inlet center 350 of the passage 320 and the rotation center 360 of the blade forms a predetermined angle with an average flowing velocity line 340, wherein it is desirable that the predetermined angle is larger than 15 degrees.

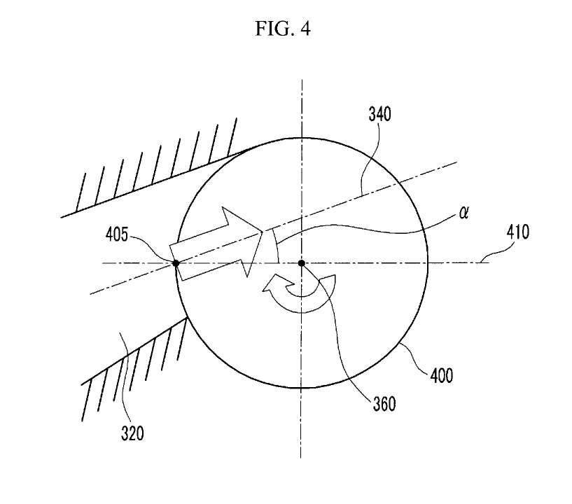

FIG. 4 is a diagram showing an air stream flowing in an anti-surge valve according to an exemplary embodiment of the present invention.

The blade of the compressor 130a has the rotation center 360, and a blade rotation trace 400 is formed along the rotation track of the blade. Further, the air passing the passage 320 to flow into the blade forms the average flowing velocity line 340.

A horizontal line 410 that passes the rotation center of the blade, and a crossing point 405 where the average flowing velocity line 340 and the blade rotation trace 400 cross, form a predetermined angle (α) with the average flowing velocity line 340. It is desirable that the predetermined angle (α) is larger than 15 degrees.

As shown in FIG. 4, the average velocity line 340 formed by the intake air flowing into the blade of the compressor 130a through the passage 320 is connected to an edge portion except the rotation center 360 of the blade such that the noise generated by the collision of the blade and the air is reduced.

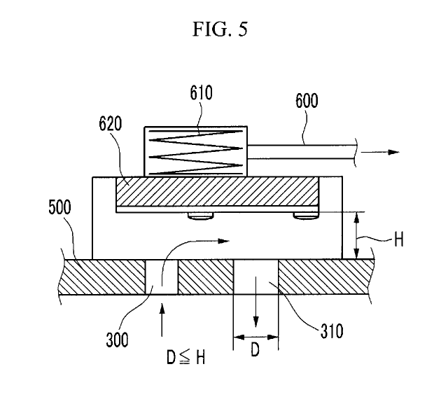

FIG. 5 is a schematic cross-sectional view of an anti-surge valve according to an exemplary embodiment of the present invention.

Referring to FIG. 5, the anti-surge valve 100 includes a valve plate 500, an opening/closing unit 620, a spring 610, and a negative pressure line 600.

An inlet 300 is formed in the valve plate 500, which is connected to the first bypass line 110a, and a passage inlet 310 is formed to be connected to the passage 320.

If the opening/closing unit 620 contacts an upper surface of the valve plate 500 by the spring 610, the inlet 300 and the passage inlet 310 are closed.

Further, if a negative pressure is formed in the negative pressure line 600, the opening/closing unit 620 is separated from the upper surface of the valve plate 620 by a predetermined distance such that the inlet 300 and the passage inlet 310 are connected.

More particularly, if a lower surface of the opening/closing unit 620 contacts the upper surface of the valve plate 500, the inlet 300 and the passage inlet 310 is closed, and if the lower surface of the opening/closing unit 620 is separated from the upper surface of the valve plate 500 by a predetermined length, the air flows through the inlet 300 and a space between the opening/closing unit 620 and the valve plate 500 to be supplied to the passage inlet 310.

In an exemplary embodiment of the present invention, while the air flowing into the inlet 300 flows in a space between the valve plate 500 and the opening/closing unit 620 and the passage inlet 310, the flowing direction of the air is converted by 180 degrees so that a whistling noise can be easily formed by the change of the flowing direction.

Meanwhile, in an exemplary embodiment of the present invention, when the opening/closing unit 620 is separated from the valve plate 500, the lift amount is equal to or larger than the diameter of the passage inlet 310 such that the noise is minimized.

In another exemplary embodiment of the present invention, when the opening/closing unit 620 is separated from the valve plate 500, the lift amount is equal to or larger than the diameter of the inlet 300 such that the noise is minimized.

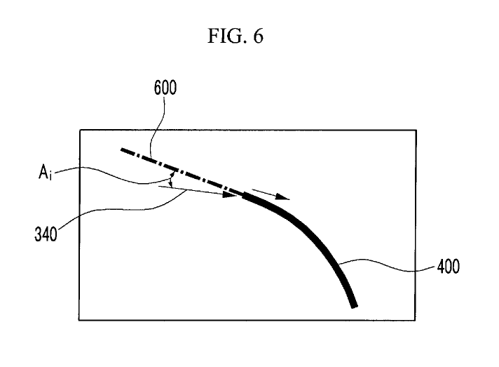

FIG. 6 is a diagram showing a principle of generating noise in a blade of a compressor according to an exemplary embodiment of the present invention.

Referring to FIG. 6, a rotation trace 400 of the blade is formed in a circle shape, an average flowing velocity line 340 is formed along the flowing line of the air, and an incident angle (Ai) is formed between a tangential line of the rotation trace 400 and the average flowing velocity line 340.

The larger the incident angle (Ai) is, the louder the noise generated by the flow separation phenomenon around the blade is, and the smaller the incident angle (Ai) is, the quieter the noise around the blade is.

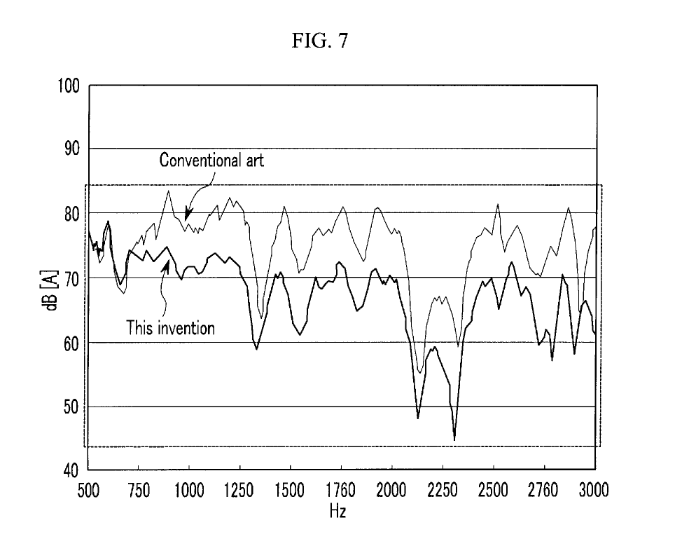

FIG. 7 is a graph showing effectiveness according to an exemplary embodiment of the present invention.

Referring to FIG. 7, the horizontal axis is frequency, and the vertical axis shows decibels (size) of the frequency. Compared with the conventional art, the size (decibels) of the noise (frequency) according to an exemplary embodiment of the present invention is remarkably deceased.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A turbocharger having an anti-surge valve, comprising:
a compressor that is disposed at an intake line to compress intake air; and
the anti-surge valve that selectively fluid-connects the downstream and the upstream of the compressor to circulate the intake air from the downstream to the upstream of the intake line,
wherein a passage communicating with the downstream of the intake line is formed in the anti-surge valve and the intake air flowing through the passage is supplied to an edge portion outside a rotation center of a blade of the compressor.

2. The turbocharger having the anti-surge valve of claim 1, wherein an average flowing velocity line of the intake air that is exhausted from the passage of the anti-surge valve to flow into the blade of the compressor is formed towards a rotating direction of the blade.

3. The turbocharger having the anti-surge valve of claim 2, wherein an inlet opening of the passage is larger than an outlet opening thereof to form a cone shape.

4. The turbocharger having the anti-surge valve of claim 3, wherein the outlet opening of the passage is aligned such that the average flowing velocity line is tangential to a rotation trace of the blade.

5. The turbocharger having the anti-surge valve of claim 1, wherein the average flowing velocity line of the intake air that is exhausted from the passage of the anti-surge valve to flow into the blade of the compressor is formed, and
a hypothetical line that connects an inlet center of the passage to the rotation center of the blade forms a predetermined angle with the average flowing velocity line.

6. The turbocharger having the anti-surge valve of claim 5, wherein an inlet opening of the passage is larger than an outlet opening thereof to form a cone shape.

7. The turbocharger having the anti-surge valve of claim 6, wherein the outlet opening of the passage is aligned such that the average flowing velocity line is tangential to a rotation trace of the blade.

8. The turbocharger having the anti-surge valve of claim 5, wherein the predetermined angle that is formed between the hypothetical line and the average flowing velocity line is at least 15 degrees.

9. The turbocharger having the anti-surge valve of claim 1, wherein the anti-surge valve includes an opening/closing unit that controls the intake air flowing into the passage, and wherein a lift height of the opening/closing unit is equal to or larger than an inlet diameter of the passage.

10. The turbocharger having the anti-surge valve of claim 9, wherein one side surface of a valve plate contacting the opening/closing unit is flat, and
the intake air flowing into an inlet of the opening/closing unit changes its moving direction 180 degrees to be exhausted through a passage inlet.

11. The turbocharger having the anti-surge valve of claim 1, wherein the average flowing velocity line of the intake air that is exhausted from the passage of the anti-surge valve to flow into the blade of the compressor is formed,
a crossing point is formed where the average flowing velocity line and a rotation trace of the blade cross each other, and
a horizontal line that passes the crossing point and the rotation center of the blade is formed, wherein the average flowing velocity line and the horizontal line form a predetermined angle.

12. The turbocharger having the anti-surge valve of claim 11, wherein an inlet opening of the passage is larger than an outlet opening thereof to form a cone shape.

13. The turbocharger having the anti-surge valve of claim 12, wherein the outlet opening of the passage is aligned such that the average flowing velocity line is tangential to the rotation trace of the blade.

14. The turbocharger having the anti-surge valve of claim 11, wherein the predetermined angle that is formed by the average flowing velocity line and the horizontal line is at least 15 degrees.
